(19) United States
(12) Patent Application Publication
(10) Pub. No.: US 2013/0086660 A1
(43) Pub. Date: Apr. 4, 2013

(54) SYSTEM FOR PREVENTING ILLEGAL COPY OF SOFTWARE AND METHOD FOR PREVENTING ILLEGAL COPY OF SOFTWARE

(71) Applicant: SAMSUNG ELECTRO-MECHANICS CO., LTD., Gyunggi-do (KR)

(72) Inventor: Dae Gil Yoon, Seoul (KR)

(73) Assignee: SAMSUNG ELECTRO-MECHANICS CO., LTD., Gyunggi-do (KR)

(21) Appl. No.: 13/624,768

(22) Filed: Sep. 21, 2012

(30) Foreign Application Priority Data
Sep. 30, 2011 (KR) 10-2011-0099790

(51) Int. Cl. G06F 21/00

(52) U.S. Cl. 726/6

(57) ABSTRACT

Disclosed herein are a system for preventing an illegal copy of software and a method for preventing an illegal copy of software. The system for preventing an illegal copy of software includes: a terminal where software to be authenticated is installed and executed; a first Zigbee device connected with the terminal in a wired method and storing a plurality of unique passwords; and a second Zigbee device connected with the first Zigbee device in a wireless method and storing at least all the unique passwords of the first Zigbee device. Utilization is improved as compared with a known hardware lock type and an illegal copy possibility by hooking is excluded and since an authentication process is performed through encoded communication by using random variables, the illegal copy of software can be thoroughly stopped.

### CROSS REFERENCE(S) TO RELATED APPLICATIONS

This application claims the benefit under 35 U.S.C. Section 119 of Korean Patent Application Serial No. 10-2011-0099790, entitled “System for Preventing Illegal Copy of Software and Method for Preventing Illegal Copy of Software” filed on Sep. 30, 2011, which is hereby incorporated by reference in its entirety into this application.

### BACKGROUND OF THE INVENTION

1. Technical Field

The present invention relates to a system for preventing an illegal copy of software and a method for preventing an illegal copy of software.

2. Description of the Related Art

In general, after a software provider sells software, a buyer legally receives all rights for the purchased software. That is, the demander installs the purchased software in his/her own system and may rent the software to other persons or sell the software by illegally copying the software.

In order to solve the above problems, various methods and systems have been proposed. These known methods may be divided into a software method and a hardware method.

First, in the software method, a unique password is assigned to a product and an application program checks the unique password to verify an authorized user or not. The method has an advantage in that the product cannot be installed when a product number is wrong, but a disadvantage in that a serial number or a unique number is easily exposed by a debug program in the system and although original software is purchased, all products can be installed by using one production number and even the product number cannot be illegally transferred, and as a result, there is a limit in preventing an illegal copy of software.

As a result, the software provider develops software at a great cost, but cannot recover investment costs due to illegal copying, transferring, renting, and the like and since there is, no cost to reinvest in developing software, software of good quality cannot be continuously developed.

Consequently, a vicious circle continuously occurs in that a software price cannot help but increase in order to recover development costs.

Meanwhile, in the hardware method, when a hardware lock which is an additional device having information required to execute software is connected to a printer port and a command is inputted in order to execute software, software is executed by sensing whether the hardware lock is connected to the printer port.

However, there have been many cases that computers produced and sold in recent years have no printer port or serial port. In this case, hardware cannot be even installed.

Moreover, an authentication signal is hooked by connecting additional equipment to the port connected with the hardware lock and the hardware lock can be incapacitated by illegally using the acquired authentication signal, and as a result, the hardware method also has a limit in view of preventing illegal copying of software.

Patent Document 1 (Korean Patent Registration No. 10-0436234) discloses a method for preventing the illegal copy using the unique password of software, but Patent Document 1 (Korean Patent No. 10-0436234) is also just a software type illegal copy preventing method and cannot present a method capable of overcoming the above limit.

### SUMMARY OF THE INVENTION

An object of the present invention is to provide a system for preventing an illegal copy of software and a method for preventing an illegal copy of software that can prevent the illegal copy of software while ensuring security of not being hooked without using a serial number that can be copied limitless in exposure.

According to an exemplary embodiment of the present invention, there is provided a system for preventing an illegal copy of software, including: a terminal where software to be authenticated is installed and executed; a first Zigbee device connected with the terminal in a wired method and storing a plurality of unique passwords; and a second Zigbee device connected with the first Zigbee device in a wireless method and storing at least all the unique passwords of the first Zigbee device.

In this case, the first Zigbee device may randomly extract one of the plurality of unique passwords, generate an authentication request message by encoding the extracted unique password, and transmit the generated authentication request message to the second Zigbee device.

The second Zigbee device may extract a unique password by decoding the authentication request message received from the first Zigbee device, and judge whether the extracted unique password matches with the unique password stored in the second Zigbee device and transmit an authentication message to the first Zigbee device when both passwords match with each other.

The authentication message may include data encoding the unique password transmitted by the first Zigbee device.

The first Zigbee device may extract a unique password by decoding the authentication message received from the second Zigbee device, and judge whether the extracted unique password matches with the unique password generated in generating the authentication message transmitted by the first Zigbee device and transmit to a terminal permission of software to be executed or installed when both passwords match with each other.

The system may further include a router relaying data transmission and reception between the first Zigbee device and the second Zigbee device through wireless communications.

The system may further include a gateway relaying data transmission and reception between the first Zigbee device and the second Zigbee device and connected with the second Zigbee device in the wired method.

According to another exemplary embodiment of the present invention, there is provided a method for preventing an illegal copy of software using a system including a terminal where software to be authenticated is installed and executed, a first Zigbee device connected with the terminal in a wired method and storing a plurality of unique passwords, and a second Zigbee device connected with the first Zigbee device in a wireless method and storing at least all the unique passwords of the first Zigbee device, the method including: (A) encoding, by the first Zigbee device, the unique password, and generating and transmitting an authentication request message including the encoded unique password; (B) decoding, by the second Zigbee device, the received authentication request message to extract the unique password; (C) judging whether the unique password extracted in step (B) matches with the unique password stored in the second Zigbee device; (D) generating, by the second Zigbee device, an authentication message and transmitting the generated authentication message to the first Zigbee device when it is judged that both unique passwords match with each other in step (C); and (E) transmitting, by the first Zigbee device, permission of software to be executed or installed, to a terminal by receiving the authentication message.

In this case, the unique password encoded in step (A) may be any one unique password randomly extracted among the plurality of unique passwords stored in the first Zigbee device

The method may further include pairing the first Zigbee device and the second Zigbee device with each other, before step (A).

In step (C), when the unique password extracted in step (B) does not match with the unique password stored in the second Zigbee device, the second Zigbee device may transmit an authentication failure message to the first Zigbee device.

According to yet another exemplary embodiment of the present invention, there is provided a method for preventing an illegal copy of software using a system including a terminal where software to be authenticated is installed and executed, a first Zigbee device connected with the terminal in a wired method and storing a plurality of unique passwords, and a second Zigbee device connected with the first Zigbee device in a wireless method and storing at least all the unique passwords of the first Zigbee device, the method including: (A) encoding, by the first Zigbee device, the unique password, and generating and transmitting an authentication request message including the encoded unique password; (B) decoding, by the second Zigbee device, the received authentication request message to extract the unique password; (C) judging whether the unique password extracted in step (B) matches with the unique password stored in the second Zigbee device; (D′) encoding, the second Zigbee device, the unique password which matches with the unique password extracted in step (B) when it is judged that both unique passwords match with each other in step (C), and generating the authentication message including the encoded unique password and transmitting the generated authentication message to the first Zigbee device; (E1′) extracting, the first Zigbee device, the unique password by receiving and decoding the authentication message; and (E2′) transmitting permission of software to be executed or installed, to a terminal when the unique password extracted in step (E1′) matches with the unique password encoded by the first Zigbee device.

### BRIEF DESCRIPTION OF THE DRAWINGS

FIG. 1 is a schematic diagram of a system for preventing an illegal copy of software according to an exemplary embodiment of the present invention;

FIG. 2 is a schematic diagram of a system for preventing an illegal copy of software according to another exemplary embodiment of the present invention;

FIG. 3 is a schematic diagram of a system for preventing an illegal copy of software according to yet another exemplary embodiment of the present invention;

FIG. 4 is a schematic diagram of a method for preventing an illegal copy of software according to an exemplary embodiment of the present invention; and

FIG. 5 is a schematic diagram of a method for preventing an illegal copy of software according to another exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

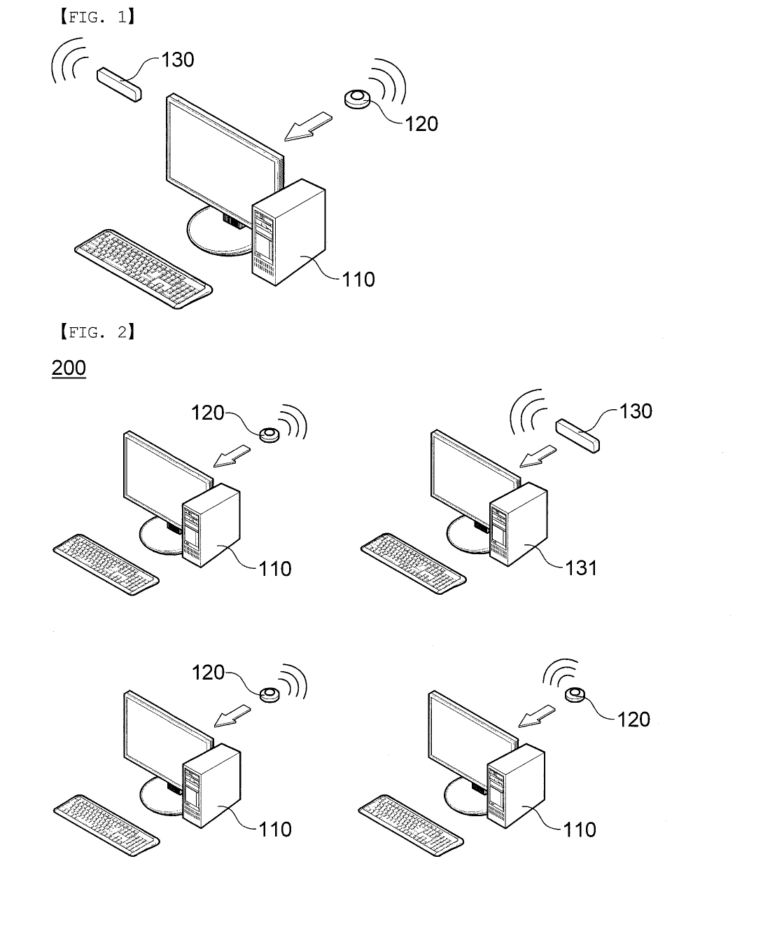

FIG. 1 is a schematic diagram of a system 100 for preventing an illegal copy of software according to an exemplary embodiment of the present invention.

Referring to FIG. 1, the system 100 for preventing an illegal copy of software according to the exemplary embodiment of the present invention may include a terminal 110, a first Zigbee device 120, and a second Zigbee device 130.

In the terminal 110, software to be authenticated, of which the illegal copy will be prevented is installed or executed. A terminal 110 such as a general personal computer or various tablet PCs may correspond to the terminal 110.

The first Zigbee device 120 and the second Zigbee device 130 transmit and receive encoded data to each other wirelessly.

In this case, a plurality of unique passwords may be stored in the first Zigbee device 120.

When authentication of software is required, the first Zigbee device 120 extracts one of the plurality of unique passwords to encode the extracted unique password. When the first Zigbee device 120 intends to installed or execute software in the terminal 110 by transmitting an authentication request message including the encoded unique password to the second Zigbee device 130 in a wireless communication method and receiving an authentication message from the second Zigbee device 130 in the wireless communication method, the first Zigbee device 120 may provide a permission signal enabling software to be installed or executed.

The second Zigbee device 130 stores all of the plurality of unique passwords stored in the first Zigbee device 120 and may be connected with an additional server 131.

Further, when the second Zigbee device 130 receives the authentication request message from the first Zigbee device 120, the second Zigbee device 130 decodes the authentication request message to extract the unique password and in this case, the second Zigbee device 130 may transmit the authentication message to the first Zigbee device by judging whether the extracted unique password matches with a unique password stored in the second Zigbee device 130.

Meanwhile, the unique password included in the authentication request message may be encoded and included in the authentication message which the second Zigbee device 130 transmits to the first Zigbee device 120.

Further, when the unique password included in the authentication message matches with the unique password which the first Zigbee device 120 transmits, the first Zigbee device 120 may provide the permission signal enabling software to be installed or executed in order to install or execute software in the terminal 110.

As a result, an illegal copy preventing function will be able to be further reinforced.

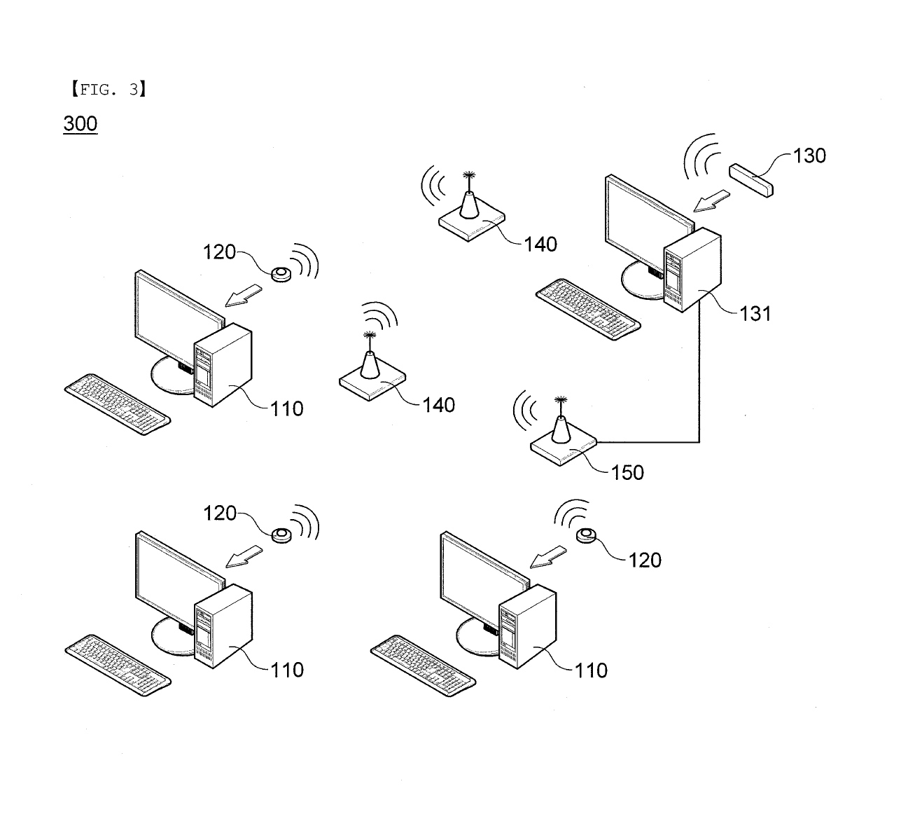

FIG. 2 is a schematic diagram of a system 200 for preventing an illegal copy of software according to another exemplary embodiment of the present invention.

Referring to FIG. 2, unlike the system 100 for preventing an illegal copy of software shown in FIG. 1, in the system 200 for preventing an illegal copy of software according to the exemplary embodiment of the present invention, a plurality of first Zigbee devices 120 and a plurality of terminals may be implemented to get permission of software to be installed and/or executed by one second Zigbee device 130.

For example, when a plurality of terminals 110 are installed in predetermined sections such as a PC room, a school, a library, a common computing room, and the like and software may be integratedly managed, the illegal software copy preventing system according to the exemplary embodiment can be usefully applied.

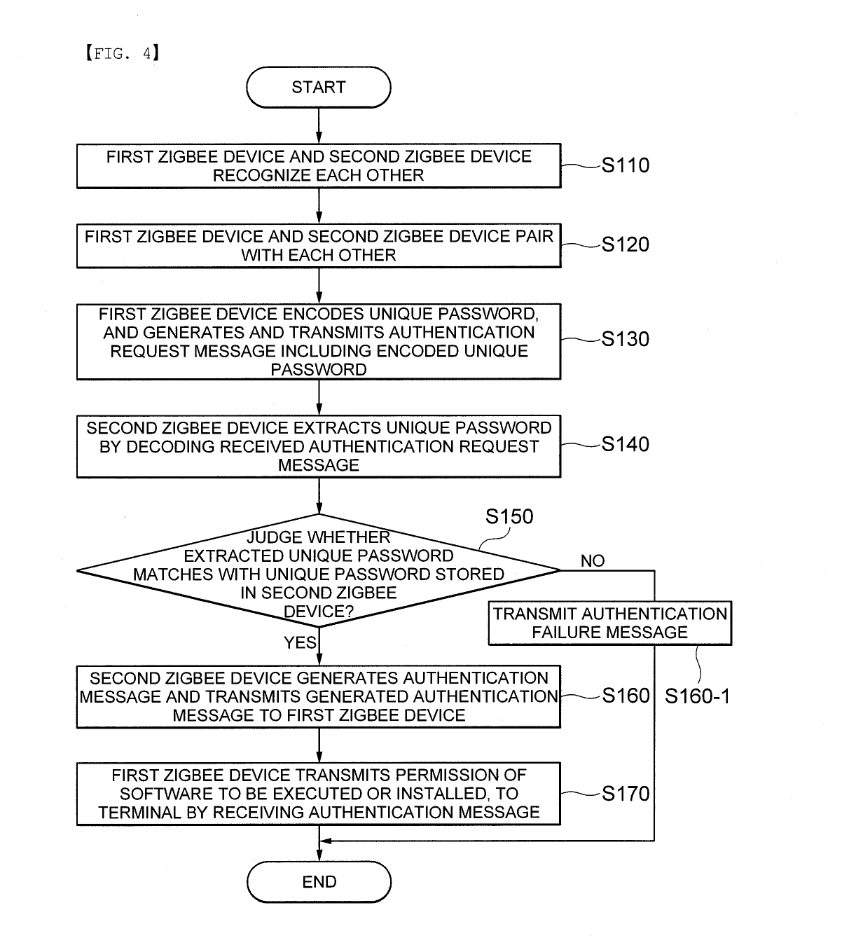

FIG. 3 is a schematic diagram of a system 300 for preventing an illegal copy of software according to yet another exemplary embodiment of the present invention.

Referring to FIG. 3, in implementing the illegal software copy preventing system 100 by the plurality of first Zigbee devices 120, the plurality of terminals 110, and one or more second Zigbee devices 130, when the distance between the first Zigbee device 120 and the second Zigbee device 130 is increased, wireless signal transmission and reception efficiency may be decreased. In this case, the illegal software copy preventing device 100 may further include a router 140 or a gateway 150 that relays a wireless transmission/reception signal between the first Zigbee device 120 and the second Zigbee device 130.

As a result, even when the terminal 110 is added while construction of the illegal software copy preventing systems 200 and 300 is completed, a software license may be conveniently applied only by adding the first Zigbee device 120. Accordingly, a cost and a procedure for switching a node lock license to a floating license can be improved.

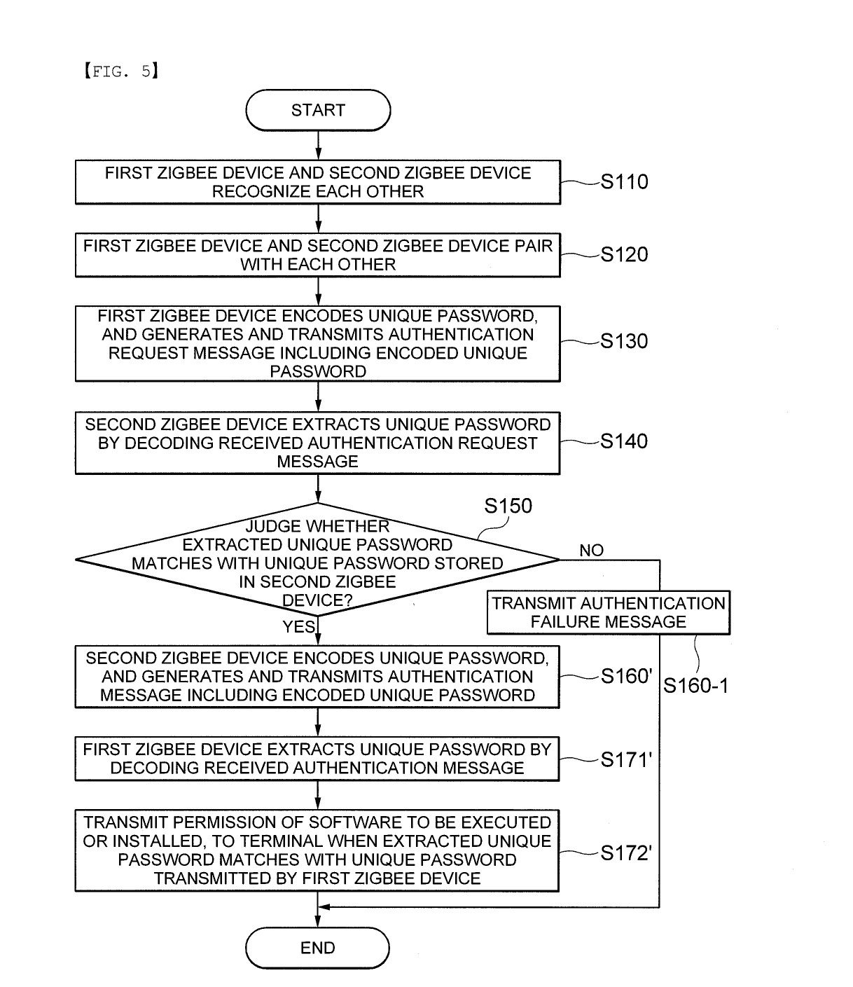

FIG. 4 is a schematic diagram of a method for preventing an illegal copy of software according to another exemplary embodiment of the present invention.

Hereinafter, the method for preventing an illegal copy of software according to the exemplary embodiment of the present invention will be described in detail.

First, a first Zigbee device 120 encodes a unique password, and generates and transmits an authentication request message including the encoded unique password (S130).

In this case, a plurality of unique passwords may be stored in the first Zigbee device 120 and any one of the plurality of stored unique passwords is extracted and encoded randomly in order to generate the authentication request message. As a result, unique passwords that are different from each other may be used for each authentication process for permitting software to be installed and executed to further reinforce an illegal copy preventing function.

Next, a second Zigbee device 130 extracts the unique password by decoding a received authentication request message (S140).

Next, it is judged whether the unique password extracted from the authentication request message matches with a unique password stored in the second Zigbee device 130 (S150).

In this case, when the unique password extracted from the authentication request message does not match with the unique password stored in the second Zigbee device 130, an authentication failure message may be transmitted (S160-1).

Meanwhile, when the unique password extracted from the authentication request message matches with the unique password stored in the second Zigbee device 130, the second Zigbee device 130 generates an authentication message and transmits the generated authentication message to the first Zigbee device 120 (S160).

Next, when the first Zigbee device 120 receives the authentication message from the second Zigbee device 130, permission is transmitted to install or execute software in the terminal 110 (S170).

Meanwhile, before step S130 is performed, a process of pairing the first Zigbee device 120 and the second Zigbee device 130 with each other may be performed (S120). Of course, during this pairing process, the first Zigbee device 120 and the second Zigbee device 130 should be recognized by each other. The pairing process may serve to generate a channel for the first Zigbee device 120 and the second Zigbee device 130 to perform encoded wireless communications with each other.

FIG. 5 is a schematic diagram of a method for preventing an illegal copy of software according to another exemplary embodiment of the present invention.

Referring to FIG. 5, unlike the case shown in FIG. 4, the unique password included in the authentication request message is encoded to be included in the authentication message generated by the second Zigbee device 130 (S160′).

Further, the first Zigbee device 120 extracts the unique password by decoding the authentication message received from the second Zigbee device 130 (S171′) and only when the extracted unique password matches with the unique password transmitted by the first Zigbee device 120, permission is transmitted to install or execute software in the terminal 110 (S172′).

As a result, an illegal copy preventing function can be further reinforced.

As set forth above, according to the exemplary embodiments of the present invention, in the system for preventing an illegal copy of software and the method for preventing an illegal copy of software, since a Zigbee device which can be connected using a USB port even without a serial port is used, utilization is improved as compared with a known hardware lock type and an illegal copy possibility by hooking is excluded and since an authentication process is performed through encoded communication by using random variables, the illegal copy of software can be thoroughly stopped.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A system for preventing an illegal copy of software, comprising:
a terminal where software to be authenticated is installed and executed;
a first Zigbee device connected with the terminal in a wired method and storing a plurality of unique passwords; and
a second Zigbee device connected with the first Zigbee device in a wireless method and storing at least all the unique passwords of the first Zigbee device.

2. The system for preventing an illegal copy of software according to claim 1, wherein the first Zigbee device randomly extracts one of the plurality of unique passwords, generates an authentication request message by encoding the extracted unique password, and transmits the generated authentication request message to the second Zigbee device.

3. The system for preventing an illegal copy of software according to claim 2, wherein the second Zigbee device extracts a unique password by decoding the authentication request message received from the first Zigbee device, and judges whether the extracted unique password matches with the unique password stored in the second Zigbee device and transmits an authentication message to the first Zigbee device when both passwords match with each other.

4. The system for preventing an illegal copy of software according to claim 3, wherein the authentication message includes data encoding the unique password transmitted by the first Zigbee device.

5. The system for preventing an illegal copy of software according to claim 4, wherein the first Zigbee device extracts a unique password by decoding the authentication message received from the second Zigbee device, and judges whether the extracted unique password matches with the unique password generated in generating the authentication message transmitted by the first Zigbee device and transmits to a terminal permission of software to be executed or installed when both passwords match with each other.

6. The system for preventing an illegal copy of software according to claim 1, further comprising a router relaying data transmission and reception between the first Zigbee device and the second Zigbee device through wireless communications.

7. The system for preventing an illegal copy of software according to claim 1, further comprising a gateway relaying data transmission and reception between the first Zigbee device and the second Zigbee device and connected with the second Zigbee device in the wired method.

8. A method for preventing an illegal copy of software using a system including a terminal where software to be authenticated is installed and executed, a first Zigbee device connected with the terminal in a wired method and storing a plurality of unique passwords, and a second Zigbee device connected with the first Zigbee device in a wireless method and storing at least all the unique passwords of the first Zigbee device, the method comprising:
(A) encoding, by the first Zigbee device, the unique password, and generating and transmitting an authentication request message including the encoded unique password;
(B) decoding, by the second Zigbee device, the received authentication request message to extract the unique password;
(C) judging whether the unique password extracted in step (B) matches with the unique password stored in the second Zigbee device;
(D) generating, by the second Zigbee device, an authentication message and transmitting the generated authentication message to the first Zigbee device when it is judged that both unique passwords match with each other in step (C); and
(E) transmitting, by the first Zigbee device, permission of software to be executed or installed, to a terminal by receiving the authentication message.

9. The method for preventing an illegal copy of software according to claim 8, wherein the unique password encoded in step (A) is any one unique password randomly extracted among the plurality of unique passwords stored in the first Zigbee device.

10. The method for preventing an illegal copy of software according to claim 8, further comprising pairing the first Zigbee device and the second Zigbee device with each other, before step (A).

11. The method for preventing an illegal copy of software according to claim 8, wherein in step (C), when the unique password extracted in step (B) does not match with the unique password stored in the second Zigbee device, the second Zigbee device transmits an authentication failure message to the first Zigbee device.

12. A system for preventing an illegal copy of software using a system including a terminal where software to be authenticated is installed and executed, a first Zigbee device connected with the terminal in a wired method and storing a plurality of unique passwords, and a second Zigbee device connected with the first Zigbee device in a wireless method and storing at least all the unique passwords of the first Zigbee device, the method comprising:
(A) encoding, by the first Zigbee device, the unique password, and generating and transmitting an authentication request message including the encoded unique password;
(B) decoding, by the second Zigbee device, the received authentication request message to extract the unique password;
(C) judging whether the unique password extracted in step (B) matches with the unique password stored in the second Zigbee device;
(D′) encoding, the second Zigbee device, the unique password which matches with the unique password extracted in step (B) when it is judged that both unique passwords match with each other in step (C), and generating the authentication message including the encoded unique password and transmitting the generated authentication message to the first Zigbee device;
(E1′) extracting, the first Zigbee device, the unique password by receiving and decoding the authentication message; and
(E2′) transmitting permission of software to be executed or installed, to a terminal when the unique password extracted in step (E1′) matches with the unique password encoded by the first Zigbee device.

13. The method for preventing an illegal copy of software according to claim 12, wherein the unique password encoded in step (A) is any one unique password randomly extracted among the plurality of unique passwords stored in the first Zigbee device.

14. The method for preventing an illegal copy of software according to claim 12, further comprising pairing the first Zigbee device and the second Zigbee device with each other, before step (A).

15. The method for preventing an illegal copy of software according to claim 12, wherein in step (C), when the unique password extracted in step (B) does not match with the unique password stored in the second Zigbee device, the second Zigbee device transmits an authentication failure message to the first Zigbee device.
